(19) United States
(12) Patent Application Publication
(10) Pub. No.: US 2017/0054789 A1
(43) Pub. Date: Feb. 23, 2017

(54) SYSTEM AND METHOD FOR SENDING ELECTRONIC FILES IN RESPONSE TO INBOUND FILE REQUESTS

(71) Applicant: LEGIST, LLC, Laguna Niguel, CA (US)

(72) Inventors: Amer Jneid, Laguna Niguel, CA (US); Priyakumar Shakti Prasad, Bangalore (IN)

(21) Appl. No.: 15/237,577

(22) Filed: Aug. 15, 2016

Related U.S. Application Data
(60) Provisional application No. 62/207,290, filed on Aug. 19, 2015.

(51) Int. Cl. H04L 29/08; H04W 12/06; H04L 29/06

(52) U.S. Cl. CPC H04L 67/06; H04L 63/0838; H04W 12/06; H04L 63/0428; H04L 63/1416

(57) ABSTRACT

System and method for sending electronic files in response to inbound file requests are disclosed. The system includes a file transfer server, a receiving party user device, and a sending party user device, all communicatively coupled together by a communications network. The file transfer server receives a request for electronic files from the receiving party user device; sends a request for the one or more electronic files to the sending party user device; receives the electronic files from the sending party user device; determines whether there are harmful elements in the electronic files; if there is none, encrypts the electronic files and makes them accessible by the receiving party user device. The sending party is only allowed a one-time session for uploading the electronic files to the server.

### CROSS REFERENCE TO RELATED APPLICATION

This application claims the benefit of the filing date of U.S. Provisional Patent Application, Ser. No. 62/207,290, filed on Aug. 19, 2015, entitled “Appright Cloud Drive Inbound Sharing Services,” which is incorporated herein by reference.

### FIELD

This disclosure relates generally to systems and methods for sending electronic files, and in particular, to a system and method for sending electronic files in response to inbound file requests.

### BACKGROUND

Email systems are known to be the main source of hacking, using attachments with embedded viruses. Unsolicited emails with attachments are very common. In addition, emails are not secure in sending sensitive information; and thus, present a risky proposition. Further, emails are not designed to handle large attachments. When needed to exchange documents with another party, primarily it is common to exchange documents using emails with attachments. Anti-Spam filters processes incoming or outgoing emails to filter suspicious activity using an imperfect algorithms resulting in blocking a great number of emails, some of which are not spam which hinders the document exchange.

### SUMMARY

An aspect of the disclosure relates to a file transfer server including a network interface and a processor. The processor is configured to receive a first request for one or more electronic files from a first device via the network interface; send a second request for the one or more electronic files to a second device via the network interface; receive the one or more electronic files from the second device via the network interface; and render the one or more electronic files accessible to the first device based on one or more conditions.

Another aspect of the disclosure relates to a receiving party user device including a network interface and a processor. The processor is configured to send a first request for one or more electronic files from a sending party to a server via the network interface; receive a notification that the one or more electronic files are available for accessing from the server via the network interface; second a second request to access the one or more electronic files to the server via the network interface; and receive the one or more electronic files from the server via the network interface.

Another aspect of the disclosure relates to a sending party user device including a network interface and a processor. The processor is configured to receive a request to upload one or more electronic files intended for a receiving party to a server via the network interface; and upload the one or more electronic files to the server via the network interface in response to the request.

Other aspects, advantages and novel features of the present disclosure will become apparent from the following detailed description when considered in conjunction with the accompanying drawings.

### BRIEF DESCRIPTION OF THE DRAWINGS

FIG. 1 illustrates a block diagram of an exemplary data communication system in accordance with an aspect of the disclosure.

FIG. 2 illustrates a flow diagram of an exemplary method of transferring one or more electronic files from a sending party to a receiving party in accordance with another aspect of the disclosure.

FIG. 3 illustrates a block diagram of an exemplary file transfer server in accordance with another aspect of the disclosure.

FIG. 4 illustrates a block diagram of an exemplary user device in accordance with another aspect of the disclosure.

FIG. 5 illustrates a flow diagram of another exemplary method of transferring one or more electronic files from a sending party to a receiving party in accordance with another aspect of the disclosure.

FIG. 6 illustrates a flow diagram of an exemplary method of requesting and receiving one or more electronic files from a sending party in accordance with another aspect of the disclosure.

FIG. 7 illustrates a flow diagram of an exemplary method of sending one or more electronic files to a receiving party in accordance with another aspect of the disclosure.

### DETAILED DESCRIPTION OF THE EXEMPLARY EMBODIMENTS

Drop Box, Box, SkyDrive, and Google drive are a few of many cloud drive services that behave similarly. Users signup to a cloud drive service to store and share files. If the user wishes to share a file from their cloud drive, it is possible to do so using standard cloud drive sharing capabilities. This process is typically referred to as an outbound share—meaning the drive owner shares documents with an outside party directly from the cloud drive after the original party has uploaded documents.

The outbound share function only addresses the distribution of documents to a recipient. However, this function does not address the process for an outside party without cloud drive services to send documents except through traditional file transfers, such as email attachments or physical media.

For example: Party A (the recipient party) is expecting a set of documents from Party B (the delivery party). In order for Party A to receive the documents, Party B must upload the documents to a cloud drive service (such as common services listed above). Through the cloud drive service, Party B shares the desired files to Party A, resulting in a notification email alerting Party A that the documents are accessible. However, this process does not incorporate Party A′s trust of Party B's cloud drive security. Alternatively, Party B can use traditional file distribution such as email—subjected to attachment limitation or spam filters—or physical media—subjected to delay of delivery.

The system for sharing or sending files as described herein (referred to in the Provisional Application as “Legist Drive”) acts and behaves similar to other cloud drive services (e.g., such as Drop Box, Box, SkyDrive, and Google drive) and provides similar outbound share services. Unlike other services, the system for sharing or sending files as described herein has a function called inbound sharing service.

The inbound sharing service operates as follows: Party A (the receiving party) is interested in receiving one or more electronic files (e.g., one or more electronic documents) from Party B (the delivery party). Through the use of the system described herein, Party A sends an email from a designated folder in a network drive to Party B. The email contains a Universal Resource Locator (URL) that when clicked grants Party B a one-time document upload to Party A's designated folder. The documents are uploaded into a holding area of the network drive. An associated network server scans the uploaded documents for viruses, encrypts the documents, and stores the documents in Party A's designated folder. The network server then sends a notification to Party A of the accessibility of the uploaded documents and terminates Party B's access or link to Party A's designated folder.

The uniqueness of the inbound sharing service described herein allows users to directly receive documents in an efficient controlled, secure process without being subjected to email system limitations or the sender's technological competency and risks. The aforementioned concept is exemplified herein with reference to the following mentioned embodiments.

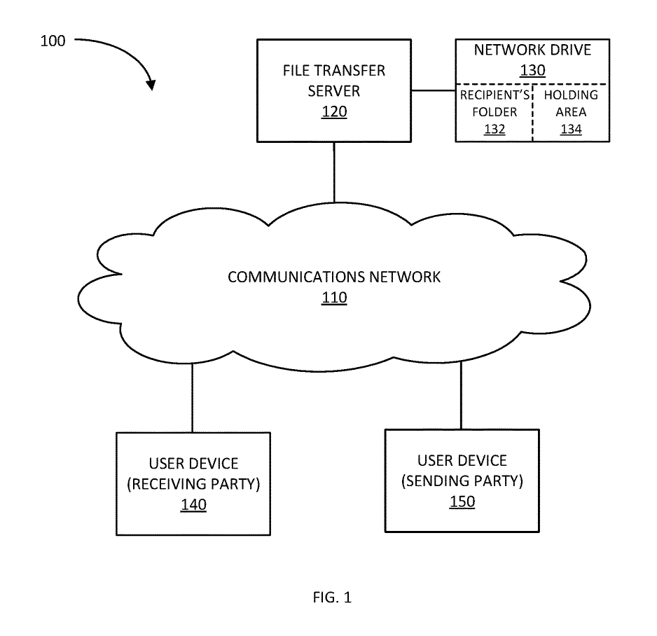

FIG. 1 illustrates a block diagram of an exemplary data communication system 100 in accordance with an aspect of the disclosure. The data communication system 100 includes a file transfer server 120, a user device (receiving party) 140, a user device (sending party) 150, all of which are coupled to a communications network 110.

The data communication system 100 further includes a network drive 130 (also known as a “cloud drive”) including a recipient's folder 132 associated with the user device 140 of the receiving party, and a holding area 134 for temporarily storing one or more electronic files, as discussed in more detail below. The network drive 130 is coupled to the file transfer server 130 directly as shown or via the communications network 110.

The communications network 110 may be any network through which data (e.g., one or more electronic files) is communicated between network devices, such as the file transfer server 120, network drive 130, and the user devices 140 and 150. Examples of the communications network 110 include a wide area network (WAN), such as the Internet, a local area network (LAN), a cellular telephone network, any combination one or more of the aforementioned networks, or other type of network.

As discussed in more detail herein, the file transfer server 120 is configured to transfer or assist in the transfer of one or more electronic files from the user device 150 of the sending party to the user device 140 of the receiving party. An electronic file is any data file, including documents, audio files, video files, multimedia files, etc.

The network drive 130 is configured to permanently and/or temporarily store one or more electronic files uploaded by the user device 150 of the sending party with an intent to transfer the one or more electronic files to the user device 140 of the receiving party. The holding area 134 (memory location) of the network drive 130 is used to initially store the one or more electronic files from the user device 150 of the sending party. The one or more electronic files in the holding area 134 are not accessible by the receiving party.

After the file transfer server 120 has analyzed or scanned the one or more electronic files for harmful elements (e.g., viruses, malware, etc.) and determined that there are no harmful elements in the one or more electronic files, the file transfer server 120 moves (e.g., physical or logically) the one or more electronic files to the recipient's folder 132 of the network drive 130 for access by the user device 140 of the receiving party. The access by the user device 140 of the receiving party would be like any authorized access to a network or cloud drive.

As discussed in more detail herein, each of the user devices 140 and 150 is an example of a device used by a user for facilitating the transfer of one or more electronic files from the user device 150 of the sending party to the user device 140 of the receiving party. A user device is any device that may send and/or receive one or more electronic files via the communications network 110. Examples of user device include desktop computers, laptop computers, smart phones, tablet devices, terminals coupled to local area networks (LANs), etc.

The following describes exemplary methods and more detail regarding a transfer of one or more electronic files from the user device 150 of the sending party to the user device 140 of the receiving party in accordance with the inbound share service described herein.

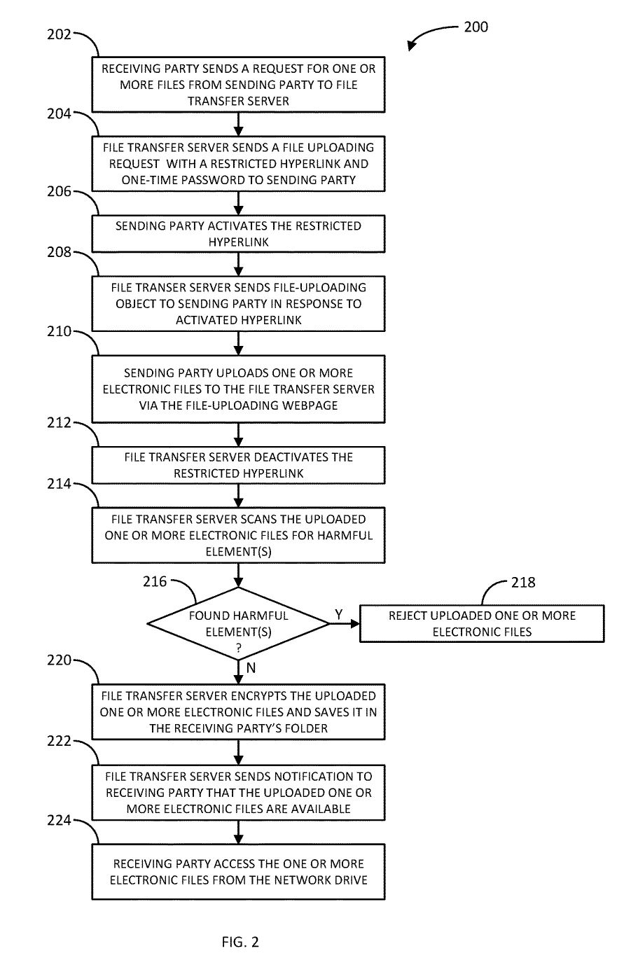

FIG. 2 illustrates a flow diagram of an exemplary method 200 of transferring one or more electronic files from a sending party to a receiving party in accordance with another aspect of the disclosure.

According to the method 200, the receiving party using the user device 140 sends a request for one or more electronic files to the file transfer server 120 via the communications network 110 (block 202). The request may be sent in many different manners, such as by accessing a secured webpage provided by the file transfer server 120, or through the use one or more software modules running on the user device 140, or through the use one or more applications running on the user device 140. The request includes information for electronically contacting the user device 150 of the sending party. Such contact information includes an email address of the sending party, a telephone number associated with the user device 150, or a client account associated with the sending party.

Then, according to the method 200, the file transfer server 120 sends a file uploading request with a restricted hyperlink and a one-time-password to the user device 150 of the sending party via the communications network 110 (block 204). The file uploading request may take on various forms, such as an email, a text message, etc. As mentioned, the file uploading request includes a restricted hyperlink accessible by the sending party using the user device 150. The hyperlink is restricted as it may not be valid after it is accessed by the sending party, such as a one-time valid hyperlink. That is, the hyperlink expires or is not valid after being activated once by the sending party. For instance, the activation of the hyperlink may require the submission of the one-time-password that may have been sent to the user device 150 of the sending party via a separate communication.

Then, according to the method 200, the sending party using the user device 150 activates the restricted hyperlink (block 206). In response to the activation of the restricted hyperlink, the file transfer server 120 sends a file-uploading object (via a webpage or application) to the user device 150 of the sending party by way of the communications network 110 (block 208). The sending party, using the file-uploading object accessed by the user device 150, uploads one or more electronic files to the file transfer server 120 via the communications network 110 (block 210). The file transfer server 120 may store the uploaded one or more electronic files in the holding area 134 of the network drive 130.

Then, according to the method 200, the file transfer server 120 deactivates the restricted hyperlink (block 212). For instance, the file transfer server 120 may invalidate the one-time-password. This prevents the sending party from re-using the same restricted hyperlink to upload additional files intended for the receiving party. As this is an inbound share service, the receiving party controls the sending of the one or more electronic files to the receiving party by the sending party.

Then, according to the method 200, the file transfer server 120 analyzes or scans the one or more electronic files for harmful elements (block 214). Such harmful elements include viruses, malware, or other elements that may cause harm to the user device 140 if accessed by the receiving party. If, in block 216, the file transfer server 120 determines that the one or more electronic files contain harmful element(s), the file transfer server 120 rejects the one or more electronic files. In other words, the file transfer server 120 does not make the one or more electronic files accessible by the receiving party. More specifically, the file transfer server 120 does not physical or logically move the one or more electronic files to the recipient's folder 132 for access by the receiving party.

If, in block 216, the file transfer server 120 determines that there are no harmful elements in the one or more electronic files, the file transfer server may optionally encrypt the one or more electronic files and then physically or logically store the encrypted file(s) in the recipient's folder 132 (another physical or logical memory location) (block 220). Thus, at this stage, the one or more electronic files are available to the receiving party just like any other file stored in the network drive 130 that is accessible by the receiving party. The file transfer server 120 then sends a notification to the user device 140 of the receiving party via the communications network 110, the notification indicating that there are one or more electronic files from the sending party available for accessing (block 222). The notification may include a list of the uploaded one or more electronic files.

Then, according to the method 200, the user device 140 of the receiving party may access the one or more electronic files from the network drive 130 via the communications network 110 (block 224). For instance, the user may click the file name displayed on the user device 140 so that the user may view, edit, and/or delete (e.g., access) the file.

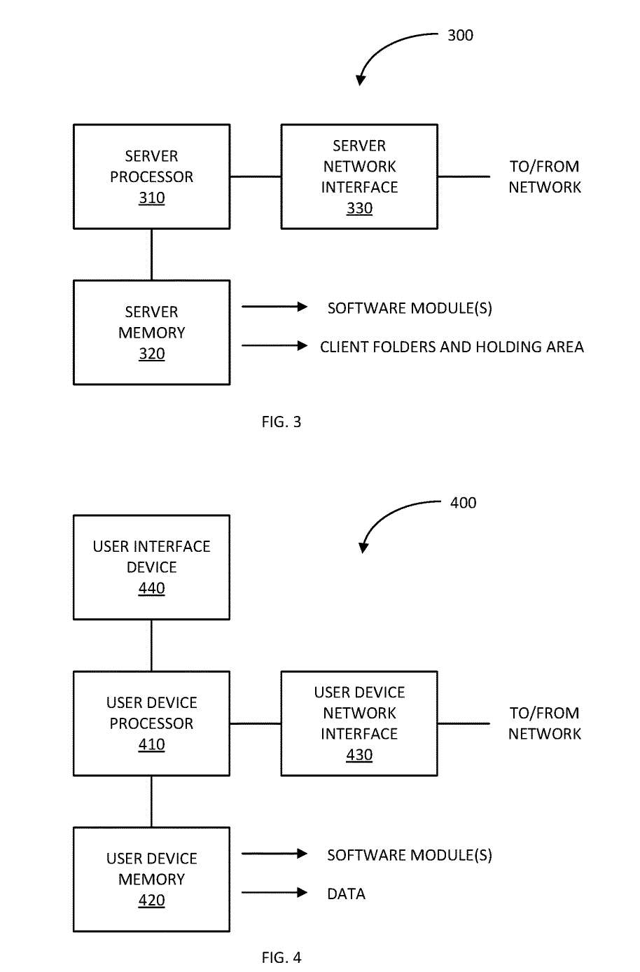

FIG. 3 illustrates a block diagram of an exemplary file transfer server 300 in accordance with another aspect of the disclosure. The file transfer server 300 may be an exemplary detailed implementation of the file transfer server 120 previously discussed.

The server 300 includes a server processor 310, a server memory 320, and a server network interface 330. The server processor 310 performs the various operations of the file transfer server 300 as previously discussed, and as discussed in more detail further herein. The server processor 310 may be any type of processing device, such as a central processing unit (CPU), or other types of processor suitable for server operations.

The server memory 320 stores one or more software modules, which may be accessed and executed by the server processor 310 to perform the various operations of the file transfer server 300 described herein. The server memory 320 may also include the network drive 130 previously described, including client folders, such as recipient's folder 132, and holding areas, such as holding area 134. Accordingly, the server memory 320 may include any combination of random access memory (RAM), non-volatile memory, hard disk drives, optical disc drives, and/or other types of software and data storage device. Although, in this example, the server memory 320 is shown as being directly connected to the server processor 310, it shall be understood that at least a portion of the server memory 320 may be accessible by the server processor 310 via the server network interface 330.

The server network interface 330 is configured to interface with the communications network 110 so as to receive information from and provide information to other network devices, such as the user devices 140 and 150, via the communications network 110. The server network interface 330 may be a wired interface or a wireless interface. Such information received include requests from the user device 140 of the receiving party (e.g., request for sending party to upload electronic file(s) and request to access the uploaded electronic file(s)), and request from the user device 150 of the sending party (e.g., request for a file-uploading webpage), and one or more electronic files from the user device 150 of the sending party. Such information provided include a file uploading request with a restricted hyperlink and a file-uploading object to the user device 150 of the sending party, and a notification of accessibility of one or more electronic files and one or more (optionally encrypted) electronic files to the user device 140 of the receiving party.

FIG. 4 illustrates a block diagram of an exemplary user device 400 in accordance with another aspect of the disclosure. The user device 400 may be an exemplary detailed implementation of any one or both of the user devices 140 and 150 previously discussed.

The user device 400 includes a user device processor 410, a user device memory 420, a user device network interface 430, and a user interface device 440. The user device processor 410 performs the various operations of the user device 400, such as the operations previously discussed with respect to user device 140 or user device 150, and as discussed in more detail further herein. The user device processor 410 may be any type of processing device, such as a CPU or any type of processor suitable for user device operations.

The user device memory 420 stores one or more software modules, which may be accessed and executed by the user device processor 410 to perform the various operations of any of the user devices described herein. The user device memory 420 may include any one or more of a RAM, non-volatile memory, hard disk drives, optical disc drives, and/or other types of software and data storage device.

The user device network interface 430 is configured to interface with the communications network 110 so as to receive information from and provide information to other network devices, such as the file transfer server 120. The user device network interface 430 may be a wired interface or a wireless interface. With regard to the user device 140 of the receiving party, such information received include notification of accessibility of one or more electronic files and one or more (optionally encrypted) electronic files. Also, with regard to the user device 140, such information provided include request for sending party to upload electronic file(s) and request to access the uploaded electronic file(s)). With regard to the user device 150 of the sending party, such information received includes a file uploading request with a restricted hyperlink and a file-uploading object. Also, with regard to the user device 150, such information provided includes an indication of the activation of the restricted hyperlink and the one or more electronic files.

The user interface device 440 may be any device that allows a user of the user device 400 to receive information from and provide information to the user device processor 410. As examples, the user interface device 440 may include a keyboard, a pointing device (e.g., mouse or track ball), a display, a touchscreen display, a speaker, a microphone, a printer, etc. In the case of user device 140 of the receiving party, the user interface device 440 allows a user to send a request for the sending party to upload one or more electronic files, receive a notification that one or more electronic files are available for accessing, send a request to access the one or more electronic files, and receive the one or more electronic files. In the case of user device 150 of the sending party, the user interface device 440 allows a user to receive a file uploading request with a restricted hyperlink, to activate the restricted hyperlink, to receive the file-uploading object, and to upload the one or more electronic files.

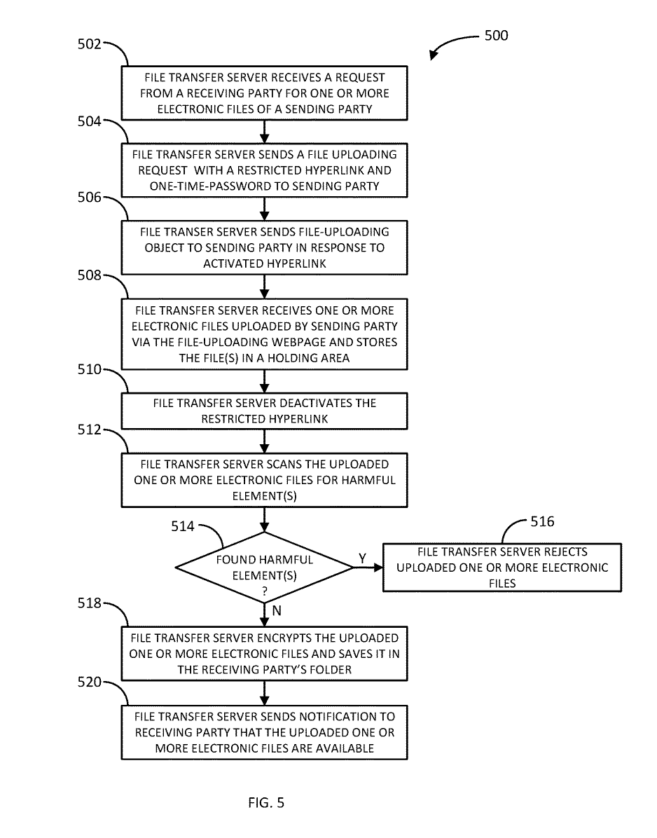

FIG. 5 illustrates a flow diagram of another exemplary method 500 of transferring one or more electronic files from a sending party to a receiving party in accordance with another aspect of the disclosure. The method 500 may be implemented by the file transfer server 300 previously discussed.

According to the method 500, the file transfer server 300 receives a request from a receiving device for one or more electronic files of a sending party (block 502). In this regard, the server processor 310 receives the request from, for example, the user device 140 of the receiving party via the communications network 110 and the server network interface 330. The request includes contact information of the sending party for sending a file uploading request to the sending party. The contact information may the sending party's email address, cell phone number, username, or others.

Then, according to the method 500, the file transfer server 300 sends a file uploading request with a restricted hyperlink and a one-time-password to the user device 150 of the sending party (block 504). In this regard, the server processor 310 sends the file uploading request to the user device 150 of the sending party via the server network interface 330 and the communications network 110. As previously discussed, the file uploading request may be an email, a text message, or other type of electronic message. Optionally, the file transfer server 300 may send a separate communication including the one-time-password to the user device of the sending party for use in accessing a file-uploading object in response to activating the restricted hyperlink.

Then, according to the method 500, the file transfer server 300 receives an indication that the restricted hyperlink has been activated by the sending party, and sends a file-uploading object to the sending party in response to the activated hyperlink (block 506). In this regard, the server processor 310 may receive the hyperlink activation indication from the user device 150 of the sending party via the communications network 110 and the server network interface 330. Additionally, the server processor 310 may send the file-uploading object (e.g., via a webpage or application command) to the user device 150 by way of the server network interface 330 and the communications network 110.

Then, according to the method 500, the file transfer server 300 receives one or more electronic files uploaded by the sending party, and stores the one or more electronic files in the holding area 134 of the network drive 130 (block 508). In this regard, the server processor 310 receives the one or more electronic files from the user device 150 of the sending party via the communications network 110 and the server network interface 330. The holding area 134 may exist in the server memory 320.

Then, according to the method 500, the file transfer server 300 deactivates the restricted hyperlink (block 510). In this regard, the server processor 310 invalidates the restricted hyperlink by causing the associated universal resource locator (URL) to point to a blank or access-denied webpage or to no network resource; thereby, not allowing the sending party to reuse the file-uploading object to upload additional files for the receiving party. Alternatively, the server processor 310 may invalidate the one-time-password to render the hyperlink useless if activated as the one-time-password or any other password provided with the activated hyperlink would not be valid.

Then, according to the method 500, the file transfer server 300 analyzes or scans the one or more electronic files for harmful element(s) (block 512). In this regard, the server processor 310 may execute one or more anti-virus and/or anti-malware software modules to determine whether the one or more electronic files have harmful element(s), such as viruses, malware, or others. If, in block 514, the server processor 310 determines that there are harmful element(s) in the one or more electronic files, the file transfer server 300 rejects the uploaded one or more electronic files (block 516). This may entail the server processor 310 deleting the one or more electronic files or making the one or more electronic files not accessible by the receiving party by not physically or logically storing the one or more electronic files in the recipient's folder 132 of the network drive 130.

If, in block 514, the server processor 310 determines that there are no harmful element in the one or more electronic files, the file transfer server 300 may encrypt the one or more electronic files and make it accessible by the receiving party, such as by physically or logically storing the one or more electronic files in the recipient's folder (block 518). In this regard, the server processor 310 may execute an encryption algorithm to encrypt the one or more electronic files, and store the encrypted one or more electronic files in the server memory 320 in a memory location or with an attribute that allows the receiving party access to the one or more electronic files.

Then, according to the method 500, the file transfer server 300 sends a notification to the receiving party indicating that the one or more electronic files uploaded by the sending party is available for accessing (block 520). In this regard, the server processor 310 sends the notification to the user device 140 of the receiving party via the server network interface 330 and the communications network 110. The notification may be in the form of an email, a text message, smart phone application notification, etc.

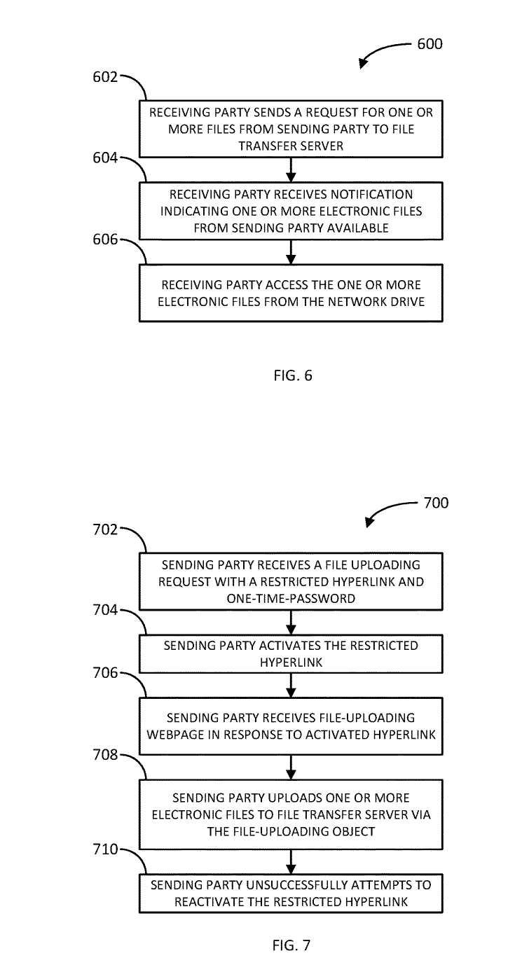

FIG. 6 illustrates a flow diagram of an exemplary method 600 of requesting and receiving one or more electronic files from a sending party in accordance with another aspect of the disclosure. The method 600 may be implemented by the user device 400 previously discussed.

According to the method 600, the user device 400 of the receiving party sends a request for one or more electronic files from a designated sending party to the file transfer server 120 (block 602). In this regard, the user device processor 410 sends the request to the file transfer server 120 via the user device network interface 430 and the communications network 110. As an example, the user device processor 410 may present a webpage from the file transfer server 120 or present a smart phone application screen to a user via the user interface device 440 to allow the user to send such a request to the file transfer server 120. The webpage or application may also prompt the user to include information for contacting the sending party (e.g., email address, telephone number, etc.).

Then, according to the method 600, the user device 400 of the receiving party subsequently receives a notification from the file transfer server 120, the notification indicating that one or more electronic files from the sending party are available for accessing (block 604). In this regard, the user device processor 410 receives the notification from the file transfer server 120 via the communications network 110 and the user device network interface 430. The notification may be in the form of an email, a phone text message, a notification on a webpage, a notification provided by a smart phone application, etc. The notification may include a list of the one or more electronic files. A user may view the notification via the user interface device 440.

Then, according to the method 600, the user device 400 of the receiving party may access the one or more uploaded electronic files from the network drive 130 (block 606). In this regard, user device processor 410 may present a webpage or application screen to the user using the user interface device 440, whereby the user may initiate the accessing of the one or more electronic files from the network drive 130. The webpage or screen may depict a network drive with folders including one having the one or more electronic files, which may be double-clicked by the user for accessing the file(s).

FIG. 7 illustrates a flow diagram of an exemplary method 700 of sending one or more electronic files to a receiving party in accordance with another aspect of the disclosure. The method 700 may be implemented by the user device 400 previously discussed.

According to the method 700, the user device 400 of the sending party receives a file uploading request with a restricted hyperlink and a one-time-password from the file transfer server 120 (block 702). In this regard, the user device processor 410 receives the file uploading request from the file transfer server 120 via the communications network 110 and the user device network interface 430. The file uploading request may be an email, a text message, smart phone application notification, etc. In addition, the user device 400 of the sending party may receive a separate communication (e.g., email, text message, etc.) including the one-time-password for use in subsequently activating the restricted hyperlink.

Then, according to the method 700, the sending party of the user device 400 activates the restricted hyperlink (block 704). In this regard, the sending party, using the user interface device 440, activates the restricted hyperlink, causing the user device processor 410 to send a URL request for a file-uploading webpage to the file transfer server 120 via the user device network interface 430 and the communications network 110. As discussed above, the user device processor 410 may prompt the user for the one-time-password via the user interface device 440, and send the URL request with the one-time-password to the file transfer server 120.

Then, according to the method 700, the user device 400 of the sending party receives a file-uploading object from the file transfer server 120 (block 706). In this regard, the user device processor 410 receives the file-uploading object (e.g., in a webpage or application screen) from the file transfer server 120 via the communications network 110 and the user device network interface 430. The file-uploading object may be presented to the user via the user interface device 440. The user device 400 may receive the file-uploading object if the user correctly entered one-time-password.

Then, according to the method 700, the user device 400 uploads the one or more electronic files to the file transfer server 120 via the file-uploading object (block 708). In this regard, the user device processor 410 sends the one or more electronic files to the file transfer server 120 via the user device network interface 430 and the communications network 110. The user device processor 410 may access the one or more electronic files stored in the user device memory 420.

Then, according to the method 700, the user of the user device 400 may unsuccessfully attempt to reactivate the restricted hyperlink (block 710). In this regard, the user may reactivate the restricted hyperlink (as well as to re-submit the one-time-password) using the user interface device 440. In response to the reactivated hyperlink, the user device processor 410 may deny sending a request for the corresponding file-uploading webpage or screen. Alternatively, the user device processor 410 may send the request to the file transfer server 120 via the server network interface 430 and communications network 110, and may subsequently receive a notification indicating that the restricted hyperlink and/or one-time-password is no longer valid; thereby, not allowing the user to send anymore files to the receiving party using that particular hyperlink.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A server, comprising:
a network interface; and
a processor configured to:
receive a first request for one or more electronic files from a first device via the network interface;
send a second request for the one or more electronic files to a second device via the network interface;
receive the one or more electronic files from the second device via the network interface; and
render the one or more electronic files accessible to the first device based on one or more conditions.

2. The server of claim 1, wherein the second request comprises a hyperlink.

3. The server of claim 2, wherein the processor is further configured to send a file-uploading object to the second device in response to an activation of the hyperlink.

4. The server of claim 3, wherein the file-uploading object is sent in an email or a text message.

5. The server of claim 2, wherein the processor is further configured to deactivate the hyperlink after receiving the one or more electronic files.

6. The server of claim 1, wherein the first request includes contact information associated with the second device.

7. The server of claim 6, wherein the contact information comprises an email address or telephone number.

8. The server of claim 1, wherein the processor is configured to scan the one or more electronic files for at least one harmful element.

9. The server of claim 8, wherein the at least one harmful element includes at least one of a virus or malware.

10. The server of claim 8, wherein the one or more conditions includes the processor not finding the at least one harmful element in the one or more electronic files.

11. The server of claim 1, wherein the processor is further configured to:
physically or logically store the one or more electronic files in a first memory location of a network drive, the first memory location not being accessible to the first device;
determine whether the one or more electronic files includes at least one harmful element; and
physically or logically store the one or more electronic files in a second memory location of the network drive if the one or more conditions include the processor determining that the one or more electronic files do not include the at least one harmful element, wherein the second memory location is accessible to the first device.

12. The server of claim 11, wherein the processor is further configured to encrypt the one or more electronic files in response to determining that the one or more electronic files do not include the at least one harmful element, wherein physically or logically storing the one or more electronic files in the second memory location comprises physically or logically storing the one or more encrypted electronic files in the second memory location.

13. The server of claim 11, wherein the processor is configured to send a notification to the first device via the network interface, the notification indicating that the one or more electronic files are in the second memory location available for accessing by the first device.

14. The server of claim 1, wherein the processor is further configured to send a file-uploading object to the second device in response to an activation of a hyperlink and receiving a valid one-time-password.

15. A user device, comprising;
a network interface;
a processor configured to:
send a first request for one or more electronic files from a sending party to a server via the network interface;
receive a notification that the one or more electronic files are available for accessing from the server via the network interface;
and
receive the one or more electronic files from a network drive via the network interface.

16. The user device of claim 15, wherein the first request includes contact information associated with the sending party.

17. The user device of claim 15, wherein the received one or more electronic files are encrypted.

18. A user device, comprising;
a network interface;
a processor configured to:
receive a first request to upload one or more electronic files intended for a receiving party to a server via the network interface; and
upload the one or more electronic files to the server via the network interface in response to the request.

19. The user device of claim 18, wherein the first request includes a one-time valid hyperlink to access a file-uploading object.

20. The user device of claim 19, wherein the processor is configured to:
send a second request for the file-uploading object to the server via the network interface in response to detecting an activation of the one-time valid hyperlink and receiving a one-time-password;
receive the file-uploading object from the server via the network interface; and
upload the one or more electronic files to the server using the file-uploading object.
